(19) United States
(12) Patent Application Publication
(10) Pub. No.: US 2022/0326110 A1
(43) Pub. Date: Oct. 13, 2022

(54) TOOL KIT FOR DETECTING LEAKAGES IN TUBES

(71) Applicant: Hamzah G. Almeghrabi, RAS TANURA (SA)

(72) Inventor: Hamzah G. Almeghrabi, RAS TANURA (SA)

(73) Assignee: Hamzah G. Almeghrabi, Ras Tanura (SA)

(21) Appl. No.: 17/226,107

(22) Filed: Apr. 9, 2021

(51) Int. Cl. G01M 3/28

(52) U.S. Cl. CPC G01M 3/2815; F28F 27/00

(57) ABSTRACT

A tool kit for testing and detecting a leakage in a tube having a cylindrical body is disclosed herein. The tool kit of the present invention comprises an inlet member and an outlet member which are going to attached with the extreme ends of the tube through a threaded mechanism. The one end of both inlet member and outlet member has a tapered structure that allows the easy insertion of both members in the openings of the tube. The tool kit further includes a fluid pump that pumps the fluid in the tube, wherein the fluid is inserted through the inlet member of the tool kit. A pressure monitoring unit is also provided with the fluid pump that measures the pressure inside the tube in real time. Furthermore, the outlet member includes a handle whose function is to control the pressure inside the tube during the testing process.

### TECHNICAL FIELD

The subject matter of the present invention relates generally to the field of leakage testing kits. More particularly, the subject matter of the present invention relates to a tube leakage testing kit and a method for testing the leakage in the tube used in a heat exchanger system.

### BACKGROUND ART

Many industrial systems and machines are used to transfer heat between two or more fluids as they are used in both cooling and heating processes. One of the most common examples of such industrial machines is a heat exchanger. These industrial systems and machines mainly consist of a series of tubes that contains fluid that must be either heated or cooled. The series of the tubes is called a tube bundle. The tubes are composed of various materials and the most commonly used tubes nowadays are made up of steel material. A hydro-test is usually performed to check for leakage in the tubes irrespective of their material of which they are composed. The most common test performed to check leakage in the tubes is “Hydrostatic Testing” which is a safe and commonly accepted approach to test pipelines and tubes for any leakage. This test typically takes about 15 minutes per coil depending on the size. In this test, a coil section is filled completely with water, one end sealed and the tube is pressurized from the opposite end. Lower pressure tests can also be performed with compressed gas, but hydrostatic leak tests are performed with water or other liquids for safety reasons. The tube is pressurized to a specified pressure greater than normal operating pressure. The test pressure is held and monitored for a set period of time.

Considering the current scenario of various industrial applications for which the tubes of industrial machines are applicable, the test for checking any leakage in the tubes has become one of the very important aspects in the industrial sector, especially in power plant generation and other safety related applications. One of the tests performed to check leakage in the tubes of the industrial machines is a pneumatic test. This “Pneumatic Test” is a type of pressure test for checking leakage in the tubes under pressurized conditions and applied to systems where the hydro-static test is difficult to apply. In the pneumatic test, air, nitrogen, or any non-flammable and non-toxic gas is used in place of water as the pressure medium. If the tubes or pipelines are to be tested for any leakage using the pneumatic test, then in that case, small segmental lengths of the tubes or pipelines are chosen at a time to carry it out. The pressure formed inside the tubes while carrying out the test is proportional to the volume of the gas provided to test maximum pressure which can be held by the tubes, in order to detect the leakage in the tubes of the heat exchanger system. But the major drawback in hydrostatic testing and the pneumatic test for detecting leakage in the tubes is that these tests must always be performed under controlled conditions. As these tests are performed under controlled conditions, there are high chances of breaking of the tubes if the water pressure or the air pressure supplied to the tubes of the heat exchanger system is extremely high.

Several prior existing systems and technologies have been developed in the past to check leakage in tubes or pipes inside the heat exchanger systems. An application number “JP6000096B2” titled “Heat Exchanger Tube Leak Inspection Jig for heat exchanger” discloses the use of a heat transfer tube leakage inspection jig in the heat exchanger system. This heat transfer tube leakage jig has a first plug in a second access screw hole facing opening of the heat transfer tube to be inspected for leakage. By screwing support plug, one opening of the heat transfer tube in which first sealing plug performs a leak test can be closed. Then, second sealing plug is inspected for leakage by screwing the second plug into first access screw hole facing the other opening of the heat transfer tube with one opening blocked. Thus, the inspection gas supply which penetrates through inside of the heat-transfer tube through the first sealing plug by plugging the opening of the both ends of the heat-transfer tube to be inspected with the first sealing plug and the second sealing plug. A closed space communicating only with the tube is formed. In this state, the test gas is pumped into the heat transfer tube in a closed space via test gas supply tube, and the test gas supply tube is closed when the heat transfer tube reaches a predetermined test pressure. Thereafter, it is possible to detect the presence or absence of leakage in the heat transfer tube by monitoring with a pressure gauge whether or not the pressure in the heat transfer tube decreases. But the main drawback of this technology is that a breakage might occur in the heat transfer tube if the pressure of the gas may go extremely high into the heat transfer tube, due to which leakage can occur easily in the heat transfer tube.

One more application number “U.S. Pat. No. 4,436,117A” titled “Leak Resistant Plug Assembly” discloses checking of leakage in tubes or pipes of the industrial machines using expandable plug assembly which is particularly suited for use in plugging tubes such as may be found in heat exchangers. The plug assembly comprises a sleeve having an end-wall and an integral deformable side-wall cooperating with the endwall to form a chamber closed at one end and open at the other. A wedge is mounted within the chamber and is slidably received within an expandable ring mounted in the sleeve adjacent its open end. When pulled axially relative to the ring, the wedge causes the sleeve to expand radially into fluid tight engagement with a surrounding surface, such as inside of a tube. A tubular retainer surrounds the out-pulled wedge and has one end which engages the ring and an opposite end which is engaged by a rotary member connected to the wedge in a threaded manner. By turning the rotary member, the wedge is tensioned for maintaining continuous outward sealing pressure against the inside of the tube over a wide range of conditions which might tend to loosen the plug assembly. But the major drawback in this technology is that due to movement of rotary member, the wedge is tensioned for maintaining continuous outward sealing pressure against the inside of the tube over a wide range of conditions which might tend to loosen the plug assembly and cause leakage of pipe due to continuous sealing pressure.

The primary challenge with the above aforementioned technologies to detect leakage in the tubes of the industrial machines is the prevention of tubes from breaking on the application of high pressure of fluid or any other medium such as air, gas passing through the tubes. Also one of the secondary challenges in the prior tube leakage detection systems is that whenever a fluid flows through the tubes of the heat exchanger in a turbulent manner (as in the turbulent flow of liquid), the eddy currents are produced due to high velocity of fluid particles and heavy accumulated scales around the surface of the tubes. This leads to friction caused between fluid layers and any puncture in the tubes of the heat exchanger system due to the friction is indicated by leakage of magnetic flux inside the tubes, resulting in a change of magnetic field in the heat exchanger. The puncture in the tubes can lead to damage to the testing kit which is used to test the tubes for any magnetic flux leakage. This type of non-destructive testing is called eddy current testing. Thus, the inability of these present systems to determine leakage of magnetic flux inside the tubes of the industrial machines in order to overcome magnetic flux leakage test limitations and uncertainty due to heavy accumulated scales is one of the secondary challenges which needs to be addressed.

Thus, there is a need for the development of an efficient, convenient, protective and economical system and method for detecting leakages in the tubes of the industrial machines, which prevents the tubes from breaking on the application of high pressure of a fluid or any other medium such as air, gas passing through the tubes and overcome magnetic flux leakage test limitations and uncertainty due to the heavy accumulated scales.

Further, limitations and disadvantages of conventional and traditional approaches will become apparent to the one skilled in the art through comparison of the described system with some aspects of the present disclosure, as set forth in the remainder of the present application and with reference to the drawings.

### OBJECTS OF THE INVENTION

Some of the objects of the present invention are listed below:

It is an object of the present invention to provide a tool kit for testing or identifying leakages in the tubes used in industrial applications, more particularly, in heat exchanger system;

It is another object of the present invention to provide a tool kit including an inlet member and an outlet member which are detachably attached with the extreme ends of the tube and tightly seals the openings of the tube.

It is another object of the present invention to provide a tool kit includes a fluid pump that injects the fluid within the tube which is going to be tested;

It is further object of the present invention to provide a tool kit comprises a pressure monitoring unit that monitors or measures the pressure of the fluid within the tube in real time and identifying the leakage in at least one of the tubes of the heat exchanging system;

It is further object of the present invention to provide a tool kit comprises an outlet member having a handle whose function is to control the pressure of the fluid inside the tube while testing the leakage;

It is further object of the present invention to provide a tool kit that can be manually controlled and easily assembled with the all types of tubes including metallic and non-metallic tubes used in the industrial sector;

It is yet another object of the present invention to provide a tool kit having an inlet member and an outlet member, wherein both inlet and outlet member has a tapered structure on their one end which enables the smooth insertion of both members within the tubes.

It is furthermore object of the present invention to provide a tool kit for testing the leakage within the tubes, which is lightweight and easy to use.

Other objects, features, advantages, and goals of the present invention will be better understood from the following detailed description taken in conjunction with the accompanying drawings.

### SUMMARY OF THE PRESENT INVENTION

The present invention provides an effective and reliable approach for the detection of leakages in the tubes used in heat exchanges system. The present invention provides a novel tool kit that is configured to attach with the extreme ends of the tubes and identify if there is any pressure drop within the tube for a pre-determined period of time.

According to an aspect of the present invention, there is provided a tool kit for testing and detecting a leakage in a tube having a cylindrical body, said tool kit comprises an inlet member having a shank whose one end has a tapered shape and other end includes a head part, the head part of inlet member is further connected to a hose connecting member; an outlet member comprising a shaft having a movable member, wherein one end of the shaft is fixed to a sealing part and other end includes a handle part, wherein the sealing part of the outlet member includes a flexible member; and a fluid pump connected to said hose connecting member through a flexible pipe, wherein the said handle of the outlet member is configured to rotate in a clockwise and an anti-clockwise direction to control the pressure inside the said tube.

In one embodiment of the present invention, the inlet member is connected to a first end of said tube through a threaded mechanism.

In one embodiment of the present invention, the outlet member is connected to a second end of said tube through a threaded mechanism.

In one embodiment of the present invention, the hose connecting member is configured to receive one end of the flexible pipe.

In one embodiment of the present invention, the inlet member includes a hollow bore through which the fluid is injected in the said tube.

In one embodiment of the present invention, the movable member moves in a back-and-forth direction with respect to the shaft portion through a threaded mechanism

In one embodiment of the present invention, the flexible member of the outlet member is detachably attached to the sealing part.

In one embodiment of the present invention, the flexible member of the outlet member is preferably made up of a Teflon material.

In one embodiment of the present invention, the fluid pump further includes a pressure monitoring unit for monitoring the pressure inside the tube.

In one embodiment of the present invention, the pressure monitoring unit includes at least one pressure gauge that monitors the pressure inside the said tube.

In one embodiment of the present invention, the said tool kit is preferably applicable to the tubes used in a heat exchanger system.

In one embodiment of the present invention, the fluid which is pumped by the fluid pump inside the tube is preferably water.

According to an aspect of the present invention, there is provided a method for testing and detecting a leakage in a tube having a cylindrical body. The method comprising the following steps, firstly, removing a pair of end cover plugs from the extreme ends (first end and second end) of the tube which is going to be tested for leakage. Secondly, threading an inlet member and an outlet member of the tool kit to the first end and the second end of the tube respectively. Thirdly, connecting a fluid pump with the inlet member of the tool kit through which the fluid is entered in the tube. Fourthly, monitoring the pressure of the fluid inside the tube using a pressure monitoring unit which may be provided in the fluid pump assembly, wherein the pressure monitoring unit includes a pressure gauge that measures the pressure of the fluid inside the tube in real time. Fifthly, if needed, adjusting the pressure of the fluid inside the tube using a handle of the outlet member, wherein the clockwise and anti-clockwise rotation of the handle causes the pressure to increase and decrease accordingly. Sixthly, checking the pressure of the fluid inside the tube for a certain period of time, once a required pressure of the fluid is achieved. Seventhly detecting the leakage inside the tube, if the tube holds the required pressure for a required amount of time, then the tube is said to be pass in the test, or if the tube is unable to hold the pressure for the required time, then the tube is said to be fail in the test.

The following detailed description is illustrative and is not intended to be in any way limiting. In addition to the illustrative aspects, embodiments, and features described above, further aspects, embodiments, and features will be apparent by reference to the following detailed description in conjunction with the accompanying drawings.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates a perspective view of an inlet member of a tool kit, in accordance with one embodiment of the present invention;

FIG. 2 illustrates a perspective view of an outlet member of a tool kit, in accordance with one embodiment of the present invention;

FIG. 3 illustrates an engagement of the tool kit in an industrial machine for detecting leakage, in accordance with an exemplary embodiment of the present invention;

FIG. 4 illustrates a cross-section view of the heat exchanger system when the inlet member and outlet member is attached with the openings of the tubes, in accordance with an embodiment of the present invention; and

FIG. 5 illustrates a method flow diagram of a tool kit for detecting the leakage inside the tube, in accordance with an embodiment of the present invention

While the present invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims and equivalents thereof.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

In the following detailed description, various specific details are set forth in order to provide an understanding of and describe the devices and techniques introduced here. However, the techniques may be practiced without the specific details set forth in these examples. Various alternatives, modifications, and/or equivalents will be apparent to those skilled in the art without varying from the spirit of the introduced mechanical components and techniques. For example, while the embodiments described herein refer to particular features, the scope of this solution also includes embodiments having different combinations of features and embodiments that do not include all of the described features. Accordingly, the scope of the techniques and solutions introduced herein are intended to embrace all such alternatives, modifications, and variations as they fall within the scope of the claims, together with all equivalents thereof. Therefore, the description should not be taken as limiting the scope of the invention, which is defined by the claims.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

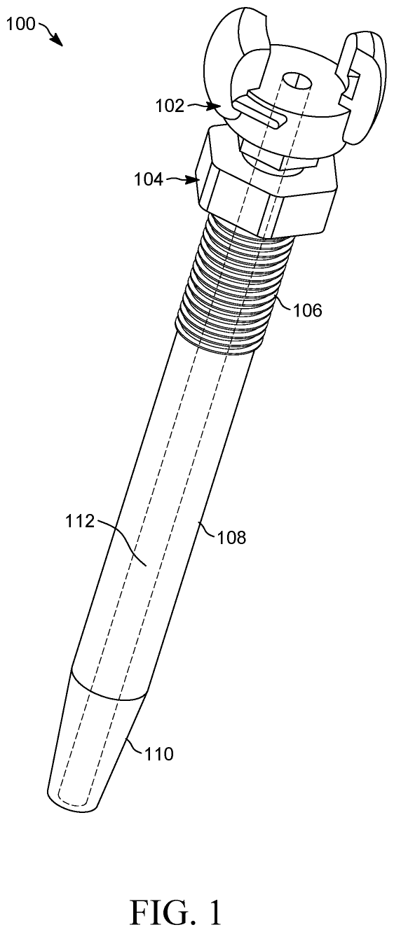

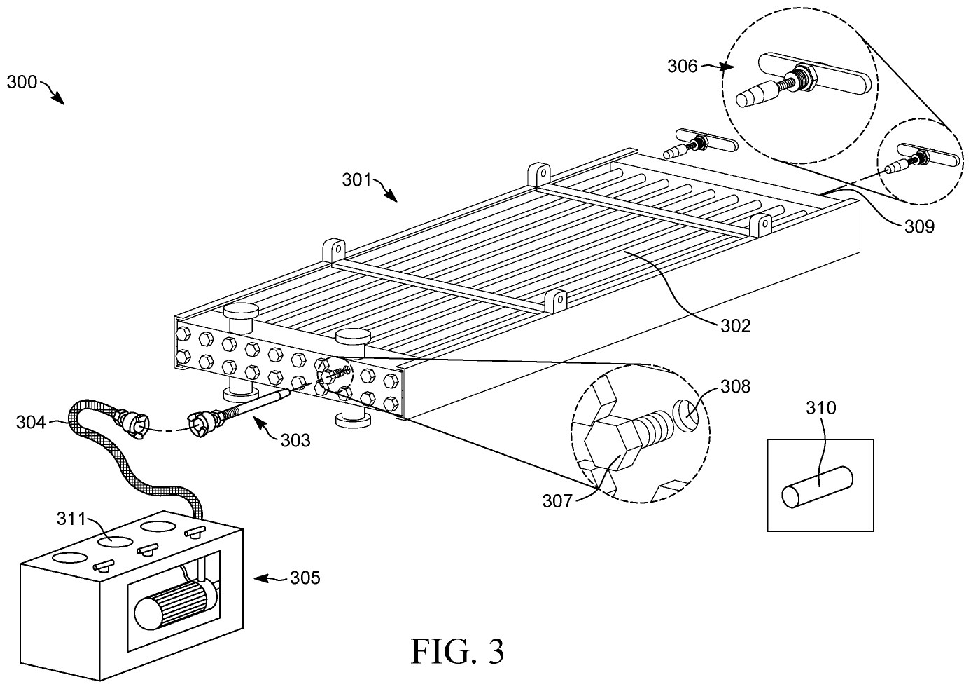

Referring now to FIG. 1 of the present invention, illustrating a perspective view of an inlet member 100 of a tool kit. As shown in figure, the inlet member 100 comprises a shank 108 whose one end (sealing end 110) preferably has a tapered structure. The tapered structure of the sealing end 110 allows the insertion of the inlet member within the opening of the tube 302 (shown in FIG. 3) at more ease and tightly seals with the tube 302. The other end of the shank 108 includes a head 104 and a plurality of male threads 106 provided on its one portion. In certain embodiments, the plurality of male threads 106 may have a helical structure enables the proper engagement of the inlet member 100 with the tube 302 which is going to be tested for leakage. More particularly, the plurality of male threads 106 is engages with the respective female threads of the tube 302 positioned on its first end, and provides effective engagement in such a way that there is no leakage between the inlet member 100 and tube 302.

The “first end” of the tube refers to the end to which the inlet member 100 is attached. The inlet member 100 with the sealing end 100 is inserted at the first end of the tube, in a manner, that the shank 108 is easily able to accommodate shell length of the tube 302. The plurality of male threads 106 of the shank 108 can completely occupy and go within the shell length of the tube 302. The inlet member 100 is connected with the first end of the tube 302 through a threaded mechanism. However, the present invention is not limited to a threaded mechanism it may include other connecting mechanism also. The other connecting mechanisms for connection of the inlet member 100 with the tube 302, here may involve connecting through a magnetic mechanism, snap and fit mechanism but not restricted to the same.

The inlet member 100 further includes a hose connecting member 102 provided at the other end of the shank. The hose connecting member 104 is detachably attached with the head of the inlet member 100 through a connecting mechanism and is configured to receive the one end of the flexible pipe 304 (shown in FIG. 3) coming out from a fluid pump 305. Through the hose connecting member 102, the fluid which is pumped out by the fluid pump 305 is injected in the tube 302 for testing purpose. The inlet member 100 includes a hollow region i.e., bore 112 which allows passage for the fluid to pass through the inlet member 100 and injected to the tube 302 that needs to be tested for leakage.

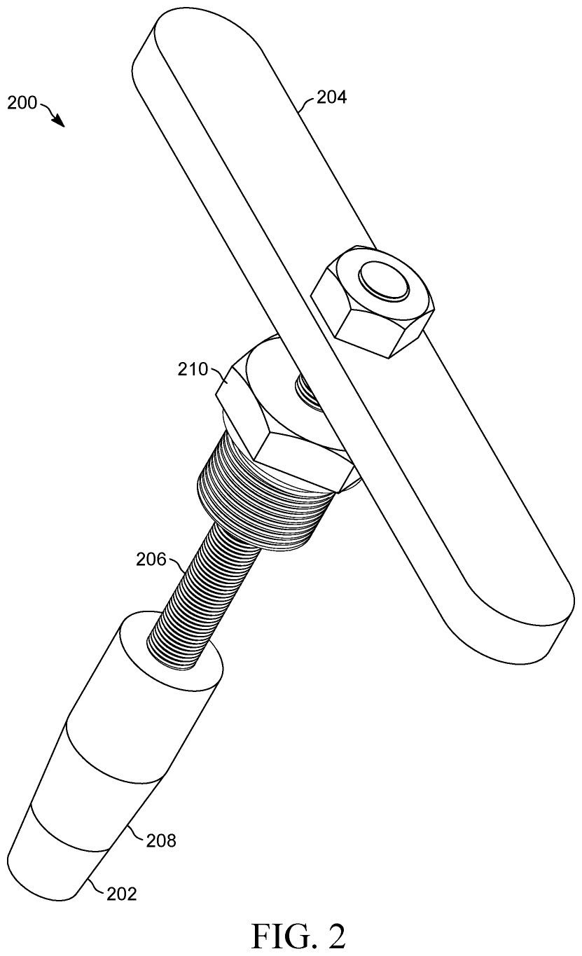

Referring to FIG. 2 illustrates a perspective view of the outlet member 200 of the tool kit. The outlet member 200 of the tool kit mainly comprises of five portions. First portion is a sealing part 202 of the outlet member 200 having a tapered structure. The tapered structure of the sealing part 202 enables the insertion of the outlet member 200 within the opening of the tube 302 (shown in FIG. 3) at more ease. The sealing part 202 is bottom part of the outlet member 200 as shown and is inserted into the tube and firmly attached to it. Second portion is the handle portion 204 which is configured to rotate in a clockwise and an anti-clockwise direction to control the pressure inside the tube. Third portion is a shaft portion 206 whose one end is connected to the sealing part 202 and the other end is connected to the handle portion 204. Fourth portion is a flexible member 208 positioned on the sealing part 202 of the outlet member 200. The flexible member 208 provides an air tight seal between the outlet member 200 and the tube 302 (shown in FIG. 3). In certain embodiments, the flexible member 208 is preferably made of Teflon material or PTFE (Polytetrafluoroethylene) material that offers excellent chemical resistivity, temperature resistivity, and non-corrosive properties. Also, its low-friction property makes it a popular material in mechanical engineering applications. In some embodiments, the flexible member 208 of the outlet member 200 is detachably attached with the sealing part 202.

Lastly, fifth portion is a movable member 210 which is able to move in a back-and-forth direction with respect to the shaft portion 206 or vice-versa, through a threaded mechanism. The movable member 210 includes a plurality of male threads 212 which can be threaded or unthreaded to the second end of the tube 302 (shown in FIG. 3) having female threads. The ‘Second End” refers to the end to which an outlet member 200 is attached. During the leakage testing and detection process, the outlet member 200 remains threaded to the second end of the tube 302 and the pressure inside the tube 302 is adjusted or controlled through the rotation of the handle 204.

Thus, it is clear from the operation of the outlet member 200 already described in detail above, that the tool kit of the present invention is efficient and economical. The tool kit of the present invention also enables detection of leakages in the tubes 302 of the industrial machines or systems, which prevents the tubes from breaking on the application of high pressure of fluid or any other medium such as air, gas passing through the tubes and overcome magnetic flux leakage test limitations and uncertainty due to the heavy accumulated scales.

Referring now to FIG. 3 illustrating an engagement of the tool kit setup 300 in an industrial machine 301 according to an exemplary embodiment of the present disclosure. The industrial machine 301 as shown in FIG. 3 is a heat exchanger, but is not restricted to the same and may be applicable to any industrial machinery or equipment. The tool kit setup 300 includes a plurality of tubes 302, an inlet member 303, an outlet member 306, a fluid pump 305, a flexible pipe 304, a first end 308 of each tube in the plurality of tubes 302, end cover plugs 307 positioned at the first end 308 and second end 309 of the tubes 302 and one or more taper plugs 310.

Before testing the leakage in the tubes 302, the end cover plugs 307 are removed or unthreaded from the respective ends (first end 308 and second end 309) of the particular tube 302. Then the inlet member 303 is threaded to the first end 308 and the outlet member 306 is threaded to the second end of the tube 302 which is going to be tested for leakage. The inlet member 303 and the outlet member 306 are properly attached to the respective ends of the tubes 302 and both ends of tube 302 are air tightly sealed. The fluid pump 305 injects the fluid into the tube 305 through a flexible pipe 304 and measures pressure inside the tube 302 using a pressure monitoring unit 311. In certain embodiments, the pressure monitoring unit 311 may include at least one pressure gauge that monitors the pressure inside the tube 302 in real time.

The fluid pump 305 mentioned as a part of the tool kit setup 300 comprises a plurality of valves which are closed automatically in an event when the pressure of fluid required to test the leakage in the tube 302 is reached and the pressure in the tube is monitored. The monitoring of pressure in the tube 302 is performed by pressure monitoring unit 311 of the fluid pump 305. When one of the tubes 302 is unable to hold the required pressure for a required period of time and found defective, then one or more taper plugs 310 shown in FIG. 3 is fitted into the respective ends of the tube 302 to block their openings.

The plurality of tubes 302 used in the industrial machine 301 can be composed of various metallic and non-metallic materials such as low carbon steel, copper, copper-nickel, stainless steel, hast-alloy, titanium, glass, plastic, or other materials. The plurality of tubes have a cylindrical body but is not intended to limit to the same. High quality electro resistance welded tubes exhibit good structure at the weld. Extruded tube with low fins is specified for certain applications. Surface enhancements are used to increase the available metal surface or support for fluid turbulence, thereby increasing the effective heat transfer rate. Finned tubing is recommended when the shell-side fluid has a substantially lower heat transfer coefficient than the tube-side fluid. The finned tubing is not finned in its landing areas, where it contacts the tube sheets. Also, the outside diameter of the finned portions of this tube design is slightly smaller than the un-finned areas. These features allow the tubes to slide easily through tube supports while still minimizing fluid bypass.

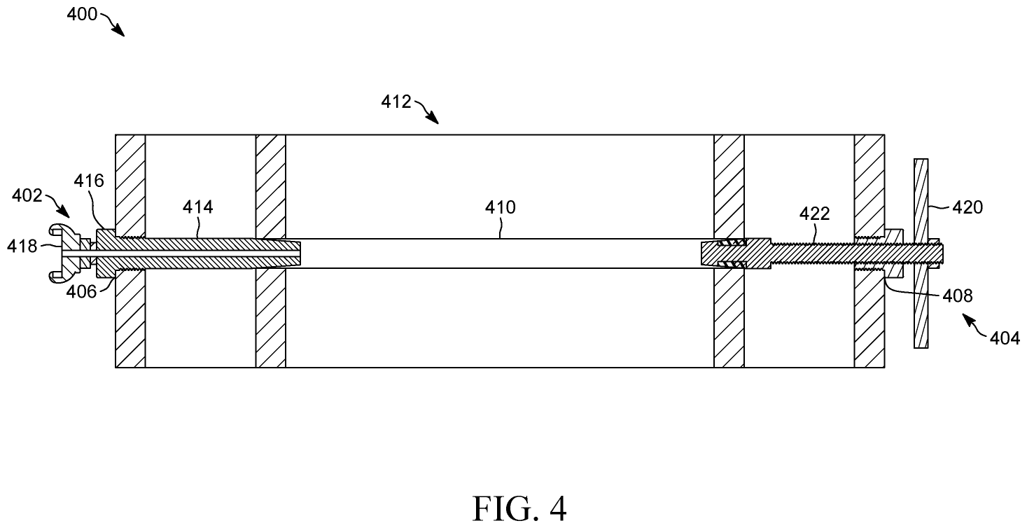

Referring to FIG. 4 illustrating a cross sectional view of tool kit setup 400 in which components of the tool kit are arranged in a particular manner according to an embodiment of the present disclosure. The tool kit setup 400 of FIG. 4 comprises an inlet member 402 and an outlet member 404 inserted at first end 406 and second end 408 of a tube 410 of an industrial machine 412. This industrial machine 412 as shown in FIG. 4 is a heat exchanger, but the industrial machine 412 is not restricted to the same. A shank 414 of the inlet member 402 is provided which is inserted at the first end 406 of the tube 410, in a manner, that the shank 414 goes deep inside the first end 406 of the tube 410, thereby accommodating shell length of the tube 410. A head portion 416 and a hose connecting member 418 of the inlet member 402 are detachably connected through a connecting mechanism. Both the head portion of the inlet member 416 and the hose connecting member 418 of the inlet member 402 lie outside the first end 406 of the tube 410, after the insertion of the inlet member 402 into the first end 406 of the tube 410. The outlet member 404 inserted at the second end 408 of the tube 410 of the industrial machine 412, comprises a handle 420 situated outside the second end 408 of the tube 410, after the insertion of the outlet member 404 into the second end 408 of the tube 410. The outlet member 404 of the tube 410 has a shaft 422 which is inserted into the second end 408 of the tube 410, in a manner that a portion of the shaft 422 when inserted inside the second end 408 accommodates the shell length of the tube at the second end 408.

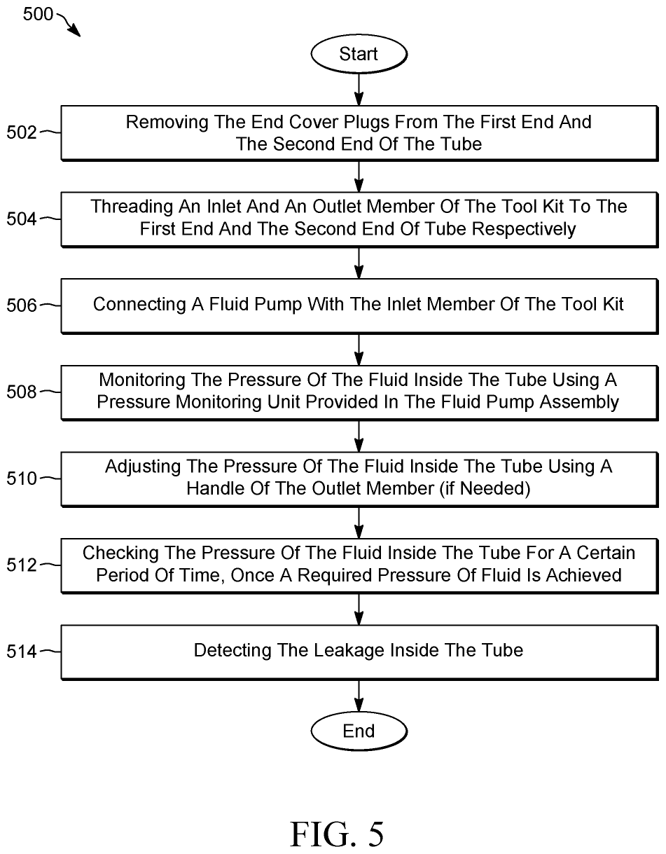

Referring now to FIG. 5 of the present invention illustrating a method flowchart 500 of a tool kit for detecting the leakage inside the tube, in accordance with an embodiment of the invention. In the first step 502, a pair of end cover plugs are removed from the extreme ends (first end second) of the tube which is going to be tested for leakage. In the second step 504, the inlet member and the outlet member of the tool kit are threaded to the first end and second end of the tube respectively. The inlet and the outlet member are detachably threaded to the first end and second end using a connecting mechanism, wherein connecting mechanism preferably includes a threaded mechanism. In the third step 506, a fluid pump is connected with the inlet member of the tool kit through which the fluid is entered into the tube.

In the fourth step 508, pressure of the fluid inside the tube is monitored using a pressure monitoring unit which may be provided in the fluid pump assembly, wherein the pressure monitoring unit includes a pressure gauge that measures the pressure of the fluid inside the tube in real time. In the fifth step 510, if needed in certain conditions where the required pressure of not achieved means the pressure inside the tube is greater or lower than the required pressure, then the pressure inside the tube is adjusted or controlled using a handle of the outlet member. The clockwise and anti-clockwise rotation of the handle causes the pressure to increase and decrease accordingly. Once the required pressure of the fluid is achieved, the pressure inside the tube is checked for a certain period of time in the sixth step 512, which can be determined by a user. In the seventh step 514, the leakage inside the tube is detected. If the tube holds the required pressure for a required period of time, then the tube is said to pass leakage test, or if the tube is unable to hold the pressure for the required time, then the tube is said to fail the leakage test.

The present invention has been described with reference to exemplary embodiments. However, it will be readily apparent to those skilled in the art that it is possible to embody the invention in specific forms other than those of the exemplary embodiments described above. This may be done without departing from the spirit of the invention. The described embodiments are merely illustrative and should not be considered restrictive in any way. The scope of the invention is given by the appended claims and their equivalents, rather than the preceding description, and all variations and equivalents which fall within the range of the claims are intended to be embraced therein. Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. In addition, while a particular feature of the invention may have been disclosed with respect to only one embodiment, such feature may be combined with one or more other features of other embodiments as may be desired or advantageous for any given or particular application.

What is claimed is:

1. A tool kit for testing and detecting a leakage in a tube having a cylindrical body, said tool kit comprises:
an inlet member having a shank whose one end has a tapered shape and other end includes a head part, the head part of inlet member is further connected to a hose connecting member;
an outlet member comprising a shaft having a movable member, wherein one end of the shaft is fixed to a sealing part and other end includes a handle part, wherein the sealing part of the outlet member includes a flexible member; and
a fluid pump connected to said hose connecting member through a pipe.
wherein the said handle of the outlet member is configured to rotate in a clockwise and an anti-clockwise direction to control the pressure inside the said tube.

2. The tool kit as claimed in claim 1, wherein said inlet member is connected to a first end of said tube through a threaded mechanism.

3. The tool kit as claimed in claim 1, wherein said outlet member is connected to a second end of said tube through a threaded mechanism.

4. The tool kit as claimed in claim 1, wherein said hose connecting member is configured to receive one end of the flexible pipe.

5. The tool kit as claimed in claim 1, wherein said inlet member includes a hollow bore through which the fluid is injected in the said tube.

6. The tool kit as claimed in claim 1, wherein said movable member moves in a back-and-forth direction with respect to the shaft portion through a threaded mechanism.

7. The tool kit as claimed in claim 1, wherein the flexible member of the outlet member is detachably attached with the sealing part.

8. The tool kit as claimed in claim 1, wherein the flexible member of the outlet member is preferably made up of a Teflon material.

9. The tool kit as claimed in claim 1, wherein the fluid pump further includes a pressure monitoring unit for monitoring the pressure inside the tube.

10. The tool kit as claimed in claim 1, wherein the pressure monitoring unit includes at least one pressure gauge that monitors the pressure inside the said tube.

11. The tool kit as claimed in claim 1, wherein the said tool kit is preferably applicable to the tubes used in a heat exchanger system.

12. The tool kit as claimed in claim 1, wherein the fluid which is pumped by the fluid pump inside the tube is preferably water.
